(19) United States
(12) Patent Application Publication
(10) Pub. No.: US 2012/0121766 A1
(43) Pub. Date: May 17, 2012

(54) Composition

(75) Inventor: Jeff Dodd, Lancashire (GB)

(73) Assignee: NATURAL BIOTECHNOLOGY SPRL, Courcelles (BE)

(21) Appl. No.: 13/375,752

(22) PCT Filed: Jun. 1, 2010
(86) PCT No.: PCT/GB2010/001082

§ 371 Date: Jan. 18, 2012

(30) Foreign Application Priority Data
Jun. 1, 2009 (GB) 0909356.8
Mar. 8, 2010 (GB) 1003768.7
Mar. 30, 2010 (GB) 1005377.5

(51) Int. Cl. A23B 7/153

(52) U.S. Cl. 426/89; 426/262; 426/654

(57) ABSTRACT

There is described a method for the prevention, mitigation or slowing of the discolouration of vegetables the method comprising: (i) an optional first step of pre-dipping the produce separately, sequentially or simultaneously in a chelating agent and an antioxidant; and (ii) treating the optionally pre-dipped vegetables with an enzyme inhibitor.

### FIELD OF THE INVENTION

The present invention relates to a novel composition and to novel methods related thereto.

More particularly, the invention relates a novel composition suitable for extending the storage life of fresh vegetables. The use of the composition and the method of the invention prevents or mitigates the spoilage of such fresh produce.

### BACKGROUND OF THE INVENTION

Enzymatic browning is one of the most studied reactions in fruits, vegetables and seafood. Researchers in the fields of food science, horticulture, plant physiology, including postharvest physiology, microbiology and insect and crustacean physiology, have studied this reaction because of the diversity of its commercial impact upon growers, food processors and consumers.

Many of the research programs have demonstrated successful formulations for preserving processed fruit, vegetables, fish, poultry and meat, but these formulations have proven commercially non-viable due to, inter alia, the expense and/or limited availability of intermediates.

Appearance, flavour, texture and nutritional value are four attributes considered by consumers when making food choices. Appearance, which is significantly impacted by colour, is one of the first attributes used by consumers in evaluating food quality.

When asked to discuss discolouration or browning in foods, those involved from production to processing, usually reflect on its detrimental influence.

Discolouration or browning in fruits and vegetables also gives rise to economic losses. Increases in fruit and vegetable markets projected for the future will not occur if enzymatic discolouration or browning is not understood more and controlled. Enzymatic discolouration and browning is one of the most devastating reactions for many exotic fruits and vegetables, in particular tropical and subtropical varieties. It is estimated that over 50% of losses in fruit occur as a result of enzymatic discolouration or browning (Whitaker and Lee, 1995). Such losses have prompted considerable interest in understanding and controlling phenol oxidase enzymes in foods. Lettuce, other green leafy vegetables, potatoes and other starchy staples, such as sweet potato, breadfruit, yam, mushrooms, apples, avocados, bananas, grapes, peaches, and a variety of other tropical and subtropical fruits and vegetables, are susceptible to discolouration or browning and therefore cause economic losses for the agriculturist. These losses are greater if discolouration or browning occurs closer to the consumer in the processing scheme, due to storage and handling costs prior to this point.

The control of discolouration or browning from harvest to consumer is therefore very critical for minimising losses and maintaining economic value to the agriculturist and food processor. Discolouration or browning can also adversely affect flavour and nutritional value of fruit and vegetables.

Decolouration, e.g. browning, of fresh produce, such as, fruit and vegetables is undesirable, especially for retailers and customers. Decolouration is unaesthetic and perceived by consumers to indicate that the produce is spoiled. Therefore, processors and retailers aim to prevent or minimise decolouration.

Such decolouration will generally not occur in undamaged or unprepared produce. However, there is an increased demand for prepared fruits and vegetables and therefore the prevention or mitigation of decolouration of such prepared foods is especially important for the retailer of such produce. If the produce is discoloured then the consumer will generally not purchase the product as it is perceived as being damaged.

Enzymic browning is an important colour reaction in fruit and vegetables and in some instances enzymic browning is desirable, for example in developing the flavour of tea and developing the colour and flavour in dried fruits such as figs or raisins.

However, enzymatic browning of many vegetables may be undesirable and can create economic losses for growers, retailers, etc. This decolouration or browning does not occur in undamaged or uncut vegetables since natural phenolic substrates are separated from the enzyme(s) responsible for browning hence the decolouration will not occur. However once the produce has been cut, peeled, damaged so that the flesh of the vegetable is exposed to air, rapid decolouration browning will occur. This discolouration or browning, of produce such vegetables, is often referred to as “enzymic browning” or “enzymatic browning”. Enzymic/enzymatic browning comprises a chemical or biochemical process which involves the enzyme polyphenol oxidase (phenolase), and other enzymes, such as, tyrosinase and catecholase. The enzyme is released when the fruit or vegetable is cut or damaged and discolouration is generally due to enzymic oxidation of phenols to orthoquinones, etc. the orthoquinones very quickly polymerise to form coloured/brown pigments known as melanins. Melanins, are a class of pigments which are derived from the amino acid tyrosine and it is the melanin, or similar compounds in its class, which produces the brown colour observed in fresh produce as hereinbefore described.

The increase in the sale of pre-prepared vegetables has increased the need for the prevention of discolouration so as to increase at least the perceived shelf life of such produce.

Conventionally, enzymatic browning is controlled with chemicals (such as sodium bisulphite), or by destroying the responsible chemicals with heat, for example, blanching is commonly used destroy the enzyme(s) and to preserve the colour in vegetables. Lemon juice and other acids have been used to preserve the colour for example in fruit, particularly apples, by lowering the pH.

However, it is important to understand the discolouration process more fully. To enable the discolouration to occur four essential components are required to be present:
1. Oxygen
2. Enzyme
3. Prosthetic group-Copper
4. Substrate

Therefore to introduce some control of enzymic browning one or more of these components needs to be eliminated from the reaction. A number of considerations need to be observed in order to understand what preventative action can be initiated to minimise browning.

### Oxygen

Removing oxygen is both difficult and impractical. Fresh produce, such as fruit and vegetables, requires oxygen to maintain normal, or a degree, of respiration. Furthermore, removal of oxygen can favour the growth of anaerobic pathogenic organisms, such as Clostridium perfringens, Clostridium botulinum and Listeria monocytogenes.

### Enzyme

Phenolase enzymes are not easily removed from fresh produce. Heating or blanching treatment has been used for many years, whilst this does inhibit phenolase and other enzymes, it also causes undesirable softening and may itself cause the formation of black discolouration, for example, as in potatoes often referred to as “after cooking darkening” or “ACD”

### Copper

Copper or iron accelerates the rate of the enzymatic browning. This can be easily observed when fruit is cut with a rusty knife or mixed in a copper bowl. The use of a chelating agent, such as, EDTA, phosphate based compounds, e.g. sodium acid pyrophosphate, and citric acid have been investigated, but have generally been unsuccessful in preventing phenolase decolouration.

A disadvantage with many conventionally known anti-browning agents is their inability to penetrate fruits and/or vegetables quickly.

Sulphites, such as sodium metabisulphite, are known to penetrate fruits and vegetables, quickly and have been used extensively with root vegetables, such as potatoes. However, the use of sulphites is disadvantageous in that, inter alia, when opening sulphite treated pre-packed vegetables, such as potatoes, there can be a “whiff” of a sulphurous odour.

Other potential anti-browning agents have been investigated including, for example, antioxidants, acidulants, chelating agents, enzyme inhibitors and inorganic salts. However, many of them suffer from the disadvantage that they are expensive and/or not commercially available.

### SUMMARY OF THE INVENTION

We have now found a novel method for the prevention, mitigations or slowing of the discolouration of produce (vegetables) the method comprising:
(i) an optional first step of pre-dipping the produce separately, sequentially or simultaneously in a chelating agent and an antioxidant; and
(ii) treating the optionally pre-dipped vegetables with an enzyme inhibitor.

Preferentially the chelating agent is one which has an affinity to copper or iron and salts thereof. Such a chelating agent is advantageously an acidulant which may also reduce the pH of the environment. An example of such a chelating agent is citric acid.

The amount of chelating agent present may vary depending upon, inter alia, the substrate being treated. However, the amount of chelating agent, e.g. citric acid, present may be from about 0.10% to about 10% (w/v) preferably from about 0.10% to about 4% (w/v).

A variety of reducing agents or antioxidants may be used which are known to the person skilled in the art, such as ascorbic acid, and salts thereof. A preferred reducing agent or antioxidant is erythorbic acid/erythorbate/kojic acid. Thus, the method may comprise the use of an antioxidant selected from one or more of ascorbic acid, erythorbic acid and kojic acid; and salts thereof. Erythorbic acid/erythorbate/kojic acid complex is an antioxidant and reducing agent which functions as a free radical scavenger preventing oxidation by altering the REDOX potential of the system and reduces undesirable oxidative products. Erythorbic acid/erythorbate/kojic acid acts as an antioxidant in that oxygen preferentially reacts with the erythorbic acid/erythorbate/kojic acid, rather than the phenolic compounds in the fruit or vegetables and therefore decolouration does not begin until all of the erythorbic acid/erythorbate/kojic acid is used up. Furthermore, erythorbic acid/erythorbate/kojic acid reduces any orthoquinones that are present to colourless diphenols.

Although a variety of antioxidants may be used a preferred antioxidant is erythorbic acid ((2R)-2-[(1R)-1,2-dihydroxyethyl]-4,5-dihydroxyfuran-3-one), and salts thereof, such as, alkali metal salts, eg sodium erythorbate. A further preferred antioxidant may be kojic acid (5-hydroxy-2-(hydroxymethyl)-4-pyrone), or a salt thereof, such as alkali metal salts, eg the sodium salt. Kojic acid is also known to be a chelating agent. A preferred antioxidant in the present invention may be a combination of erythorbic acid, or a salt thereof and kojic acid, or a salt thereof.

The amount of the antioxidant, e.g. a mixture of two or more of erythorbic acid/erythorbate salt/kojic acid, present may also vary and may be from 0.05% (w/v) to about 9% preferably from about 0.01 to about 5%. When the antioxidant comprises a mixture or complex of erythorbic acid/erythorbate salt/kojic acid the ratio of erythorbic acid/erythorbate salt: kojic acid may be from about 1:10 to 10:1, preferably about 1:5 to 5:1, more preferably from about 1:2 to 2:1, e.g. about 1:1.

Preferentially, the method of the invention comprises the simultaneous treatment of vegetables with a chelating agent and enzyme inhibitor. Thus, the chelating agent citric acid and antioxidant erythorbic acid/erythorbate/kojic acid complex may be present together in a solution and the produce may be dipped in the solution to achieve the desired effect.

A variety of enzyme inhibitors may be utilised in the process of the invention. In one aspect of the invention the enzyme inhibitor comprises a combined treatment of an acidulant and a reducing agent or antioxidant. In the combined treatment according to this aspect of the invention may comprise the use separately, sequentially or simultaneously of an acidulant and a reducing agent or antioxidant.

In another aspect of the invention the enzyme inhibitor is a modified acidified salt. The acidified salt may be acidified sodium chloride, e.g. sodium hydrogen sulphate (NaHSO₄). The modified acidified salt may be a mixture of sodium hydrogen sulphate/glycerol complex e.g. the acidified salt may be dissolved in an ascorbic acid/glycerol solution. The modified acidified salt may function as an acidulant and thereby has an inhibitory effect on phenolase, for example, by reducing the pH to below the level at which is required to inactivate phenolase. The optimum pH of phenolase activity varies with the source of the enzyme and the particular substrate, e.g. fruit or vegetable, etc., but generally phenolase has an optimum activity at a pH of from 6 to 7. Therefore, according to this aspect of the invention the acidulant is selected from those that will reduce the pH to below 6. In an especially preferred aspect of the invention the acidulant will reduce the pH to about 2.45

The amount of acidulant, e.g. acidified sodium chloride, present in the enzyme inhibitor may vary and may be from about 1% to about 6% (w/v), preferably from about 1% to about 4% (w/v).

The reducing agent or antioxidant in the enzyme inhibitor may comprise one or more of the antioxidants as hereinbefore described, such as a complex of erythorbic acid/erythorbate salt/kojic acid. The amount of antioxidant present in the enzyme inhibitor may vary and maybe from 0.1% to about 5% (w/v), preferably 0.5% to about 3.8% (w/v), more preferably from about 0.5% to about 2% (w/v).

According to one aspect of the invention we provide a method as herein before described wherein the pre-dipping step is present.

According to an alternative aspect of the invention we provide a method as hereinbefore described wherein the pre-dipping step is absent.

Therefore, according to a further aspect of the invention we provide a composition suitable for the prevention of the discolouration of produce vegetables) comprising an optional pre-dipping component and an enzyme inhibitor component.

According to one aspect of the invention we provide a composition as hereinbefore described in which the pre-dipping component is present.

According to an alternative aspect of the invention we provide a composition as hereinbefore described in which the pre-dipping component is absent.

According to a yet further aspect of the invention we provide a kit suitable for the prevention of the discolouration of produce (vegetables) the kit comprising:
(i) an optional pre-dipping component as hereinbefore described; and
(ii) an enzyme inhibitor component as hereinbefore described.

According to one aspect of the invention we provide a kit as hereinbefore described in which the pre-dipping component is present.

According to an alternative aspect of the invention we provide a kit as hereinbefore described in which the pre-dipping component is absent.

In the composition or kit as hereinbefore described, the optional pre-dipping component may comprise a chelating agent, e.g. citric acid, and an antioxidant, e.g. erythorbic acid/erythorbate/kojic acid complex. Thus, as hereinbefore described the chelating agent should have an affinity to copper or iron and salts thereof. It will be understood that more than one chelating agent may be present, for example, a copper selective chelating agent may be combined with an iron selective chelating agent. The chelating agent may be an acidulant which may reduce the pH of the environment, such as citric acid.

In the kit of the invention as hereinbefore described the chelating agent may be presented. in a single composition or solution, or separate.

In the composition or kit as hereinbefore described, the enzyme inhibitor may comprise a combined treatment of an acidulant and a reducing agent. Such a combined acidulant and a reducing agent is a modified acidified salt, such as acidified sodium chloride. Therefore, the acidulant is selected from those that will reduce the pH to below 6. In an especially preferred aspect of the invention the acidulant will reduce the pH to about 2.8.

In the composition or kit as hereinbefore described, the reducing agent or antioxidant may preferentially be erythorbic acid or erythorbate salt (Na⁺, K⁺Ca²⁺) or kojic acid either as separates or in a number of combinations.

According to a yet further aspect of the invention we provide (vegetables) treated with a process, kit or composition as hereinbefore described. Such produce is advantageous in that, inter alia, if it has been peeled, it has an improved shelf life. By the term shelf life used herein, we mean the period for which the produce may be kept without discolouration, alteration to taste and texture occurring.

Such vegetables are advantageous in that, inter alia, if they have been peeled and/or blanched, they have an improved shelf life/By the term shelf life used herein, we mean the period for which the vegetables may be kept without discolouration, alteration to colour, taste and/or texture occurring.

In particular aspect of the present invention we provide potatoes treated with an enzyme inhibitor as hereinbefore described prior to being treated with oil. The invention especially potatoes which have simultaneously blanched and treated with an enzyme inhibitor.

As hereinbefore described potatoes treated in this way are especially advantageous in that they exhibit a reduced uptake of toxins such as acrylamides. Therefore according to a yet further aspect of the invention we provide a method of reducing the uptake of toxins, such as acrylamides, in potatoes which comprises treating the potatoes with an enzyme inhibitor.

The prevention, mitigation or slowing of the spoilage of vegetables, such as potatoes, as hereinbefore described may comprise the mitigation of decolouration. However, in addition to the removal or mitigation of discoloration of vegetables, the method of the invention is also advantageous in that, inter alia, it can reduce the amount of undesirable amides, such as polyacrylamides, which can contaminate vegetables that have been in contact with cooking oil, e.g. have been fried or partially fried. Although the process by which the method of the invention reduces polyacrylamide contamination is not well understood, it is believed to be due the ability of the enzyme inhibitor to prevent the acrylamide from penetrating the surface of the vegetables.

Thus, according to a further aspect of the invention we provide a method of reducing or preventing the build up of polyacrylamides in vegetables, such as potatoes, which comprises treating the vegetables with an effective amount of an enzyme inhibitor as hereinbefore described. This aspect of the invention is especially useful in treating, for example, potatoes, which may be partially cooked or fried prior to being chilled or frozen. It will be understood by the person skilled in the art that when vegetables, such as potatoes, are prepared for cooking in oil they may be blanched prior to coming into contact with the oil. It is a particular advantage of this aspect of the invention that the enzyme inhibitor may be added to the blanching solution and thereby the vegetables may be treated to prevent acrylamide uptake and be blanched at the same time.

Therefore, according to this aspect of the invention we further provide a method of preparing vegetables, such as potatoes, for cooking with oil, which comprises blanching the vegetables and separately, sequentially or simultaneously treating with an enzyme inhibitor as hereinbefore described.

The method according to this aspect of the invention is advantageous in that, inter alfa, it has been shown to reduce acrylamide uptake in potatoes by up to 80%.

In a further particular aspect of the present invention we provide vegetables or produce that are derived from the fruit of the African baobab (or monkey bread) tree treated with an enzyme inhibitor as hereinbefore described.

The method according to this aspect of the invention may comprise treating the potatoes after removal of the surface skin with the enzyme inhibitor and prior to them being cooked or partially cooked in oil. Such a method may comprise treated the potatoes separately, sequentially or simultaneously as they are being blanched.

Therefore, according to a further aspect of the invention we provide a blanching medium which comprises an aqueous medium including an enzyme inhibitor as hereinbefore described.

The invention will now be described by way of example only.

### Example 1

### Anti Browning and Prevention of After Cooking Darkening of Potatoes

This study is focussed on:
1. The Anti Browning and Prevention of ACD (After Cooking Darkening) of potatoes using a two phase treatment with citric acid. and antioxidant erythorbic acid/erythorbate/kojic acid complex Citric acid (Pre-wash) and modified natural acidified salt (Enzyme Inhibitor)
2. The inhibitors are microbiologically safe but are equally anti microbial themselves.
3. Commercially feasible, cost effective as a preservative and by extending the shelf life of the produce.
4. Minimising the need to modify in-house processing plant and equipment.

The study takes into account the relevance and importance of retaining by minimising loss of:
1. Natural flavour
2. Colour
3. Texture
4. Overall appearance

Part (1) of Study—The Anti Browning and Prevention of ACD (After Cooking Darkening) of Marius Piper and Estema potatoes.

The Pre Dip:
Is the organic acidulant citric acid functions as a chelating agent, chelating the copper at the enzyme—active site and antioxidant erythorbic acid/erythorbate/kojic acid complex

The Enzyme Inhibitor:
Is a modified acidified sodium chloride/glycerol complex solution, which functions as an acidulant and has an inhibitory effect on phenolase by reducing the pH to below 4 the level at which phenolase is inactivated. The optimum pH of phenolase activity varies with the source of the enzyme and the particular substrate, but generally it has an optimum pH of 6-7.

and
Erythorbic acid/erythorbate salt/kojic acid complex a reducing agent which functions as a free radical scavenger preventing oxidation by altering the REDOX potential of the system and reduces undesirable oxidative products. The main role of erythorbic acid/erythorbate salt/kojic acid complex is to reduce the orthoquinones to colourless diphenols.

Fresh potatoes have a pH of about 5.2-5.8. Hence the role of the acidulant is to maintain the pH below that necessary for optimal enzyme/catalytic activity.

Preparation:

The concentrations of the Prewash and Enzyme Inhibitor used are preferably kept to a minimum

Pre Dip (citric acid. and antioxidant erythorbic acid/erythorbate salt/kojic acid complex needs to be 0.10% to about 5.00% (w/v).

Enzyme Inhibitor (needs to be 0.05% to about 4% (w/v) modified acidified sodium chloride/glycerol complex and erythorbic acid/erythorbate salt/kojic acid complex 0.5% to about 3.8% (w/v).

Packaging: The potatoes after treatment were stored in polythene bags which are semi permeable to oxygen and carbon dioxide so an equilibrium** concentration of both gases may be established when the rate of gas transmission through the bag is equal to the rate of respiration (this is “equilibrium modified atmosphere” or “EMA”) so as to maintain aerobic conditions required for regular respiratory activity of the potatoes. **Preferably the equilibrium modified atmosphere in the bag is about 1%-10% oxygen and 1%-10% carbon dioxide under refrigerated conditions at temperature of 5° C.

Absence of oxygen (anaerobic conditions) can result in off-flavour development particularly in peeled potatoes facilitating toxin production by microorganisms, for example, Clostridium botulinum, at storage temperatures above 4° C.-5° C. Our research into the use of semi permeable polythene bags has, after treatment, facilitated a shelf life of 9 days.

Mode of Application:
1. Peeled (by abrasion) followed by a potable water wash, the potatoes as chips, diced and whole are pre dipped for 1-2 minutes by mobile immersion in Pre wash

These are then dipped for 31/2 minutes in the enzyme inhibitor
2. The potatoes are then drained and packed into semi-permeable polythene bags then placed into cold storage at 5° C.-7° C.
3. The potatoes were then examined daily—visually for any colour change, taste and texture and then photographed.
4. Controls were also prepared:
Peeled potatoes (Un treated)
Peeled Potatoes dipped in potable cold water.
Peeled Potatoes dipped in pre-wash
Peeled Potatoes dipped in enzyme inhibitor

Results:

1. After 7 days the treated potatoes remained in very good condition retaining original taste, colour and texture.
2. On the 7^{th} day a portion of the potatoes were blanched at 75° C. for 7 minutes, cooled and packed into a polythene bag. No ACD was identified for 5 days thereafter.
3. The same results were evident for boiled potatoes.
4. Taste and texture were not affected.
5. Peeled potatoes (Un treated)—After a few hours light browning appeared

Peeled Potatoes as chips, diced and whole dipped in potable cold water—after day one (1) very light browning was observed.

Peeled Potatoes as chips, diced and whole dipped in prewash—after two (2) days light browning was observed. Taste as expected for potatoes. Texture firm.

Peeled Potatoes as chips, diced and whole dipped in enzyme inhibitor—after 5 days some of the potatoes exhibited light browning. Taste as expected for potatoes. Texture firm.

1. A method for the prevention, mitigation or slowing of the discolouration of vegetables the method comprising:
(i) an optional first step of pre-dipping the produce separately, sequentially or simultaneously in a chelating agent and an antioxidant; and
(ii) treating the optionally pre-dipped vegetables with an enzyme inhibitor.

2. A method according to claim 1 wherein the chelating agent has an affinity for copper or iron and salts thereof.

3-4. (canceled)

5. A method according to claim 1 wherein the amount of chelating agent present is from about 0.1% to about 10% (w/v).

6. (canceled)

7. A method according to claim 1 wherein the antioxidant is ascorbic acid.

8. A method according to claim 1 wherein the antioxidant is an erythorbic acid/erythorbate/kojic acid complex.

9. A method according to claim 1 wherein the amount of antioxidant is from 0.05% to about 9% (w/v).

10. A method according to claim 1 which further comprises the simultaneous treatment of vegetables with the chelating agent and the enzyme inhibitor.

11. A method according to claim 1 wherein the enzyme inhibitor comprises an acidulant.

12. A method according to claim 1 wherein the enzyme inhibitor comprises a combination of an acidulant and a reducing agent.

13. A method according to claim 12 wherein the acidulant is a modified acidified salt.

14-21. (canceled)

22. A method of reducing or preventing the build up of polyacrylamides in vegetables which comprises treating the vegetables with an effective amount of an enzyme inhibitor.

23. A method according to claim 22 wherein the method includes a step of pre-dipping the vegetables in a chelating agent.

24. A method according to claim 22 wherein the vegetables are potatoes.

25-27. (canceled)

28. A method according to claim 1 which comprises blanching the vegetables, wherein the vegetables are blanched and simultaneously, sequentially or separately treated with the enzyme inhibitor, whereby the vegetables thereby prepared are suitable for subsequent cooking with oil.

29. A method according to claim 1 wherein the vegetables are potatoes.

30. A method according to claim 29 wherein the potatoes have a reduced acrylamide uptake.

31. A composition suitable for the prevention of the discolouration of produce comprising an optional pre-dipping component and an enzyme inhibitor component.

32-41. (canceled)

42. A composition according to claim 31 wherein the enzyme inhibitor is an acidulant.

43. (canceled)

44. A composition according to claim 42 wherein the acidulant is a modified acidified salt.

45-74. (canceled)

75. Produce treated according to the method of claim 1.

76. (canceled)

77. Produce treated with the composition of claim 31.
